(19) United States
(12) Patent Application Publication
(10) Pub. No.: US 2013/0046549 A1
(43) Pub. Date: Feb. 21, 2013

(54) METHOD AND SYSTEM FOR SOCIAL ENTERPRISE PORTFOLIO MANAGEMENT

(71) Applicants: David J. Colby, San Francisco, CA (US); Andrew I. Gordon, San Francisco, CA (US); Erik Manuevo, Campbell, CA (US)

(72) Inventors: David J. Colby, San Francisco, CA (US); Andrew I. Gordon, San Francisco, CA (US); Erik Manuevo, Campbell, CA (US)

(73) Assignee: salesforce.com, inc., San Francisco, CA (US)

(21) Appl. No.: 13/445,565

(22) Filed: Apr. 12, 2012

Related U.S. Application Data
(60) Provisional application No. 61/524,935, filed on Aug. 18, 2011.

(51) Int. Cl. G06Q 10/06

(52) U.S. Cl. 705/1.1

(57) ABSTRACT

Systems and methods are provided for social enterprise portfolio management. A database system can use subscription information for project portfolio records to enable system users to subscribe to receive timely updates of these records, in contrast to the system users waiting for periodic project reports when projects meet various milestones. The database system can provide updates about any modifications of specified portfolio records to subscribed system users via feeds to display devices, enabling these system users to respond promptly to these updates. For example, subscribed system users can request and receive updates for portfolio records for viewing in one location, which enables subscribed system users to prioritize responses to updates. A system user can select to subscribe to updates of portfolio records, thereby relieving some of a project manager's responsibility for providing every subscription detail for the project manager's project.

### CLAIM OF PRIORITY

This application claims the benefit of U.S. Provisional Patent Application 61/524,935 entitled SOCIAL ENTERPRISE PORTFOLIO MANAGEMENT, by Colby et al., filed Aug. 18, 2011 (Attorney Docket No. 734PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending United States patents and patent application, including the present application, are related to each other. The other application is incorporated by reference herein in its entirety: U.S. patent application Ser. No. 12/945,417 entitled SYSTEM AND METHOD FOR SUBSCRIPTIONS FOR ENTERPRISE LEVEL BUSINESS INFORMATION NETWORKING, by Lee et al., filed Nov. 11, 2010 Attorney Docket No. 021735-005920US.

### PROJECT MANAGEMENT

One or more implementations relate generally to project management in a computing environment.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional project management, a project stakeholder may have to wait for a report about a project when the project meets a milestone before the stakeholder learns about the status of the project. By then, a stakeholder's action may be too late to address an issue with the project in a timely manner, thereby resulting in the increase of the project's risk factors. If the stakeholder attempts to review all of the information about the project stored in a database system, the stakeholder may become overwhelmed by the incredible amount of project information and confused by some detailed information that may be difficult to understand, thereby overlooking project information relevant to the stakeholder's interests. Furthermore, the stakeholder may waste a significant amount of time organizing and archiving each email and communication about the project, yet be unable to find a crucial communication about the project at a later date.

Accordingly, it is desirable to provide techniques enabling project management implemented by a database system to improve the performance, efficiency, and the ease of use of project management.

### BRIEF SUMMARY

In accordance with embodiments, there are provided systems and methods for social enterprise portfolio management. These systems and methods for social enterprise portfolio management can enable embodiments to use subscription information for project portfolio records that enable system users to subscribe to receive timely updates of these records, in contrast to the system users waiting for periodic project reports. The ability of embodiments to provide these subscriptions can enable a database system to provide updates about any modifications of specified portfolio records to subscribed system users via feeds to display devices, enabling these subscribed system users to respond promptly to these updates. Embodiments also provide the capacity for users to collaborate on records they care about and promotes transparency, traceability of decisions in a social manner. Group decisions can be facilitated, made, and documented, all on the appropriate request, project, program, and portfolio records without using email or other legacy methods.

In an embodiment and by way of example, a method for social enterprise portfolio management is provided. The method embodiment includes subscribed system users requesting and receiving updates for portfolio records for viewing in one location, which enables the subscribed system users to prioritize responses to updates. A system user can select to subscribe to updates of portfolio records, thereby relieving some of a project manager's responsibility for providing every subscription detail.

While one or more implementations and techniques are described with reference to an embodiment in which social enterprise portfolio management is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements.

Although the following figures depict various examples, the one or more implementations are not limited to the examples depicted in the figures.

FIG. 1 is an operational flow diagram illustrating a high level overview of a method for social enterprise portfolio management in an embodiment;

FIG. 2 is another operational flow diagram illustrating a high level overview of a method for social enterprise portfolio management in an embodiment;

FIG. 3 is yet another operational flow diagram illustrating a high level overview of a method for social enterprise portfolio management in an embodiment;

FIG. 4 is a further operational flow diagram illustrating a high level overview of a method for social enterprise portfolio management in an embodiment;

FIG. 5 is a screen shot illustrating a frame of an example user interface screen supporting methods for social enterprise portfolio management;

FIG. 6 illustrates a block diagram of an example of an environment wherein an on-demand database service might be used; and

FIG. 7 illustrates a block diagram of an embodiment of elements of FIG. 6 and various possible interconnections between these elements.

### DETAILED DESCRIPTION

### General Overview

Systems and methods are provided for social enterprise portfolio management.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing social enterprise portfolio management will be described with reference to example embodiments.

The following detailed description will first describe subscription information that enables system users to receive timely updates of portfolio records in accordance with aspects and embodiments. Providing updates for modifications of portfolio records to system users is then detailed. Following the description of providing updates for modifications of portfolio records, system users requesting and receiving updates for portfolio records for viewing in one location is described. Then a system user selecting to subscribe to updates of portfolio records is described. Next, a screen shot illustrating a frame of an example user interface screen is described.

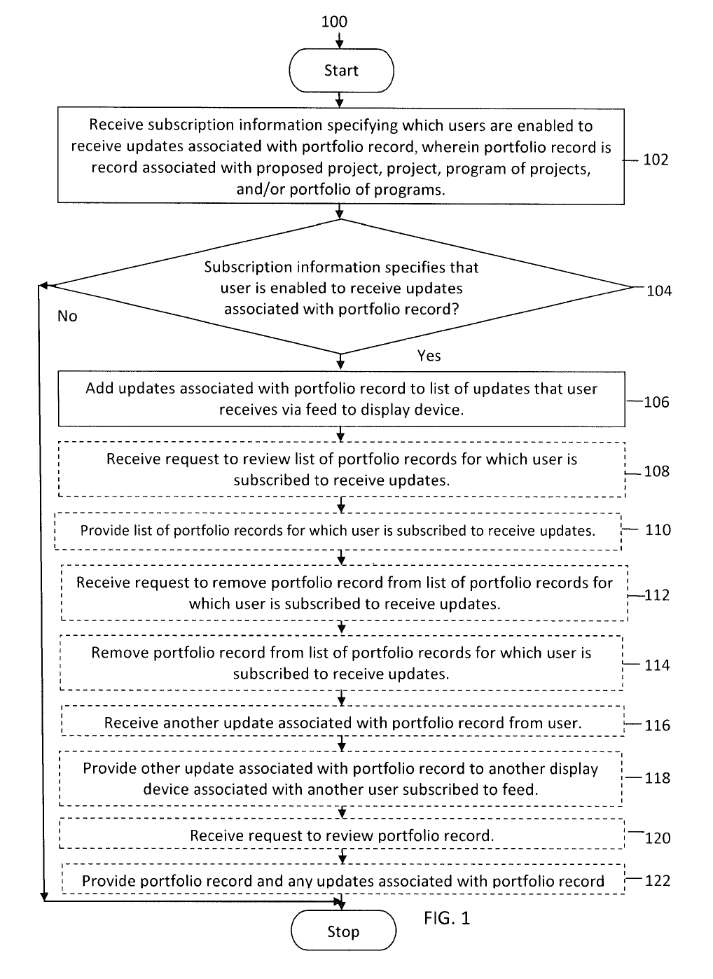

FIG. 1 is an operational flow diagram illustrating a high level overview of a method 100 for social enterprise portfolio management in an embodiment. As shown in FIG. 1, a database system can use subscription information for project portfolio records to enable system users to subscribe to receive timely updates of these records, in contrast to the system users waiting for periodic project reports.

In block 102, subscription information is received specifying which users are enabled to receive updates of a portfolio record, wherein the portfolio record is a record for a proposed project, a project, a program of projects, and/or a portfolio of programs. For example and without limitation, this can include the database system receiving subscription information from a small project's manager hat enables a large project's manager to receive updates for a small project's due date because the project manager's large project depends on the small project completing by the due date. In some embodiments, each project manager accesses the database system or the project manager's own projects, thereby providing the subscription information that subscribes other users to receive updates for the project manager's own portfolio records. The portfolio record may also be a report for a portfolio record and/or a dashboard for a portfolio record. For example, any reports generated when a project reaches a conventional milestone may also be provided as an update to users who subscribe to the project's records.

In block 104, a determination is made whether subscription information specifies that a user is enabled to receive updates of a portfolio record. By way of example and without limitation, this can include the database system verifying that subscription information provided by the small project's manager enables the manager of the large project to receive updates for the small project's due date. If the subscription information specifies that the user is enabled to receive updates of the portfolio record, the method 100 continues to block 106. If the subscription information does not specify that the user is enabled to receive updates of the portfolio record, the method 100 stops.

In block 106, updates of the portfolio record are added to a list of updates that the user receives via a feed to a display device. In embodiments, this can include the database system adding updates of the small project's due date to the list of updates that the manager of the large project receives via the feed to the handheld computing device, mobile phone, laptop computer, and work station of the manager of the large project. These updates may enable the manager of the large project to take action in a timely manner shortly after information about other projects change, rather than waiting for reports about other projects when the other projects meet various milestones.

In block 108, a request is optionally received to review the list of portfolio records for which the user is subscribed to receive updates. For example and without limitation, this can include the database system receiving a request from the small project's manager to review a list of portfolio records, including the small project's due date, for which other users are subscribed to receive updates.

In block 110, the list of portfolio records for which the user is subscribed to receive updates is optionally provided. By way of example and without limitation, this can include the database system providing the list of portfolio records, including the small project's due date, for which users are subscribed to receive updates.

In block 112, a request is optionally received to remove portfolio record from the list of portfolio records for which the user is subscribed to receive updates. In embodiments, this can include the database system receiving a request from a previously completed project's manager to remove a previously completed project's due date from the list of portfolio records for which the manager of the large project is subscribed to receive updates.

In block 114, the portfolio record is optionally removed from the list of portfolio records for which the user is subscribed to receive updates. For example and without limitation, this can include the database system removing the previously completed project's due date from the list of portfolio records for which the manager of the large project is subscribed to receive updates. A project manager may periodically evaluate the subscription information for the project manager's project, that determines which portfolio records are updated for which users to reduce the provision of unnecessary updates, thereby assisting users to focus on the remaining updates received. Subscriptions to updates of portfolio records enable each system user to focus only on records that are relevant to the system user, instead of being overwhelmed by an incredible amount of portfolio records, such that project managers periodically refining the updates enables a system user to retain a sharp focus on relevant records.

In block 116, another update associated with the portfolio record is optionally received from the user. By way of example and without limitation, this can include the database system receiving a message about the small project's delayed due date from the manager whose large project depends on the small project completing by the small project's previous due date. Receiving another update associated with the portfolio record from the user may subscribe a previously unsubscribed user to receive updates associated with the portfolio record. For example, the large project manager's message about the small project's delayed due date may provide an identifier for the large project manager's supervisor that subscribes this supervisor to receive this message from the manager of the large project.

In block 118, the other update associated with the portfolio record is optionally provided to another display device of another user subscribed to the feed. In embodiments, this can include the database system providing the large project manager's message about the small project's delayed due date to the handheld computing device, mobile phone, laptop computer, and work station of the large project manager's supervisor because the this supervisor is now subscribed to the feed. This update may enable the large project manager's supervisor to take action in a timely manner shortly after information about other projects change, such as consulting with other supervisors about the impact of the delay for the large project, rather than waiting for reports about other projects when the other projects meet various milestones.

In block 120, a request is optionally received to review the portfolio record. For example and without limitation, this can include the database system receiving a request from the manager of the large project to review the project due date for the small project.

In block 122, the portfolio record and any updates associated with the portfolio record are optionally provided to the display device. By way of example and without limitation, this can include the database system providing the small project's due date and all updates associated with the small project's due date to the handheld computing device, mobile phone, laptop computer, and work station of the manager of the large project. The ability to review all of the updates associated with the small project's due date in one location reduces the probability that the manager of the large project will waste a significant amount of time organizing and archiving each email and communication about the small project's due date. The capability for fields and records to “talk” to users enables portfolio management by exception, instead of constant reactive searching for information.

The method 100 may be repeated as desired. Although this disclosure describes the blocks 102-122 executing in a particular order, the blocks 102-122 may be executed in a different order.

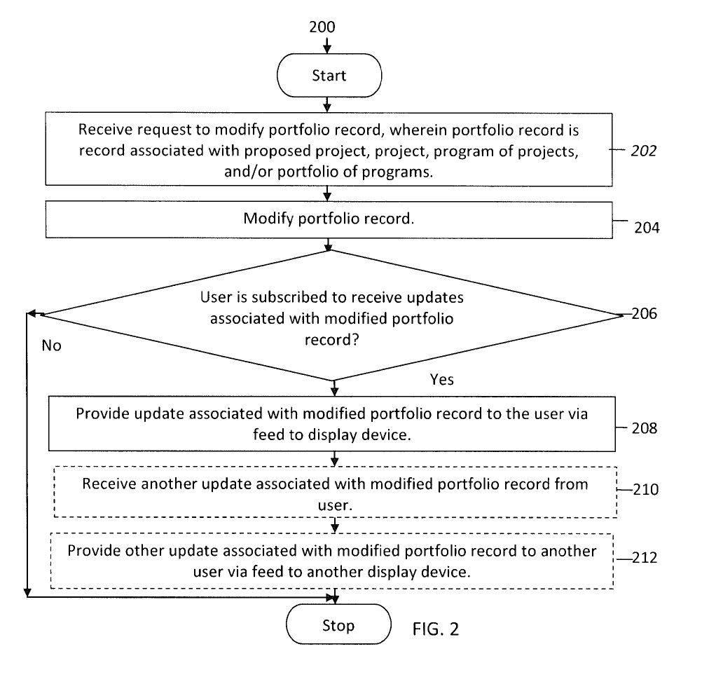

FIG. 2 is another operational flow diagram illustrating a high level overview of a method 200 for social enterprise portfolio management in an embodiment. As shown in FIG. 2, modifications of specified portfolio records results in providing updates about these modifications to subscribed system users via feeds to display devices, enabling these subscribed system users to respond promptly to these updates.

In block 202, a request is received to modify a portfolio record, wherein the portfolio record is a record for a proposed project, a current project, a program of projects, and/or a portfolio of programs. For example and without limitation, this can include the database system receiving a request from an engineer working on an expensive project to modify the expensive project's health status from “on target” to “watch.”

In block 204, the portfolio record is modified. By way of example and without limitation, this can include the database system modifying the expensive project's health status from “on target” to “watch.”

In block 206, a determination is made whether a user is subscribed to receive updates of the modified portfolio record. In embodiments, this can include the database system determining whether the manager of the large project is subscribed to receive updates of the expensive project's health status. If the user is subscribed to receive updates of the modified portfolio record, the method 200 continues to block 208. If the user is not subscribed to receive updates of the modified portfolio record, the method 200 stops.

In block 208, an update of the modified portfolio record is provided to the user via the feed to the display device. For example and without limitation, this can include the database system providing the update of the expensive project's modified health status to the manager of the large project via the feed to the handheld computing device, mobile phone, laptop computer, and work station of the manager of the large project. This update may enable the manager of the large project to take action in a timely manner shortly after information about other projects change, rather than waiting for reports about other projects when the other projects meet various milestones.

In block 210, another update associated with the modified portfolio record is optionally received from the user. By way of example and without limitation, this can include the database system receiving a message from the manager of the large project about the expensive project's modified health status. Receiving the other update associated with the modified portfolio record from the user may enable another user to receive updates associated with the modified portfolio record. For example, the large project manager's message about the expensive project's modified health status may provide an identifier for a human resource manager that subscribes the human resource manager to receive the message from the manager of the large project.

In block 212, the other update associated with the modified portfolio record is optionally provided to the other user via the feed to the other display device. In embodiments, this can include the database system providing the message from the manager of the large project about the expensive project's modified health status to the computing device, mobile phone, laptop computer, and work station of the human resource manager because the human resource manager is now subscribed to the feed. This update may enable the human resource manager to take action in a timely manner shortly after information about other projects change, such as requesting some engineers from inexpensive projects to volunteer to reassign to the expensive project, rather than waiting for reports about other projects when the other projects meet various milestones. These updates enable users such as the human resource manager and some engineers for the inexpensive projects to make decisions in a transparent way in groups without the overhead of emails and traditional committees.

The method 200 may be repeated as desired. Although this disclosure describes the blocks 202-212 executing in a particular order, the blocks 202-212 may be executed in a different order.

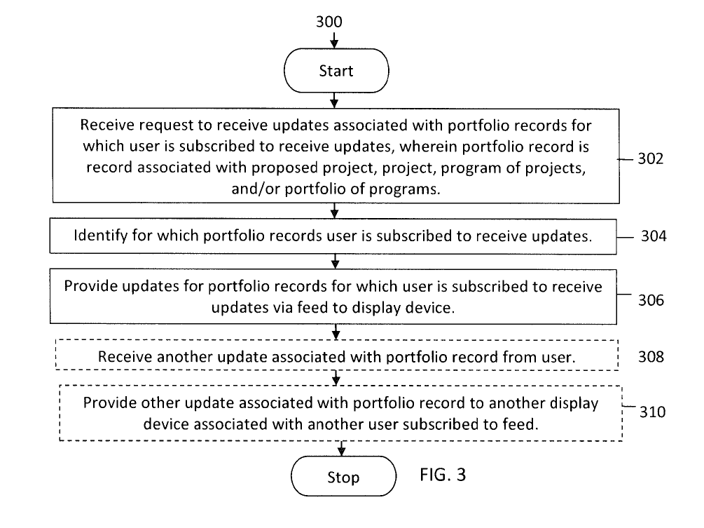

FIG. 3 is yet another operational flow diagram illustrating a high level overview of a method 300 for social enterprise portfolio management in an embodiment. As shown in FIG. 3, subscribed system users can request and receive all of their updates for portfolio records for viewing in one location, which enables the subscribed system users to prioritize responses to updates.

In block 302, a request is received to receive updates associated with portfolio records for which the user is subscribed to receive updates, wherein a portfolio record is a record for a proposed project, a project, a program of projects, and a portfolio of programs. For example and without limitation, this can include the database system receiving a request from the manager of the large project to receive updates associated with portfolio records for which the manager of the large project is subscribed to receive updates, such as updates for the small project's due date and the expensive project's health status.

In block 304, for which portfolio records the user is subscribed to receive updates are identified. By way of example and without limitation, this can include the database system identifying the small project's due date and the expensive project's health status as portfolio records for which the manager of the large project is subscribed to receive updates.

In block 306, updates of portfolio records for which the user is subscribed to receive updates are provided via the feed to the display device. In embodiments, this can include the database system providing updates for the small project's due date and the expensive project's health status to the handheld computing device, mobile phone, laptop computer, and work station of the manager of the large project. When the manager of the large project accesses portfolio record updates via a handheld computing device, mobile phone, laptop computer, and/or work station, this manager may review all of the updates in one location, which is a beneficial context for this manager to prioritize actions based on the updates. For example, the manager of the large project may prioritize which action to take first, informing the manager's supervisor about the small project's delayed due date or informing the human resource manager about the expensive project's modified health status. Promptly providing a group of updates to the manager of the large project may enable this project manager to take action in a timely and prioritized manner shortly after information about other projects change, such as informing the manager's supervisor and the human resource manager, rather than waiting for reports about the other projects when the other projects meet various milestones.

In block 308, another update associated with a portfolio record is optionally received from the user. For example and without limitation, this can include the database system receiving a message about the small project's delayed due date and a message about the expensive project's modified health status from the manager of the large project. Receiving the update associated with the portfolio record from the user may enable another user to receive updates associated with the portfolio record. For example, the large project manager's message about the small project's delayed due date may provide an identifier for this manager's supervisor that subscribes this manager's supervisor to receive this manager's message. In another example, the large project manager's message about the expensive project's modified health status may provide an identifier for a human resource manager that subscribes the human resource manager to receive this message from the manager of the large project.

In block 310, the other update associated with the portfolio record is optionally provided to another display device associated with another user subscribed to the feed. By way of example and without limitation, this can include the database system providing the large project manager's message about the small project's delayed due date to the handheld computing device, mobile phone, laptop computer, and work station of this manager's supervisor and providing this manager's message about the expensive project's modified health status to the handheld computing device, mobile phone, laptop computer, and work station of the human resource manager. These updates enable system users to automatically trace decisions and interactions to each corresponding portfolio record.

The method 300 may be repeated as desired. Although this disclosure describes the blocks 302-310 executing in a particular order, the blocks 302-310 may be executed in a different order.

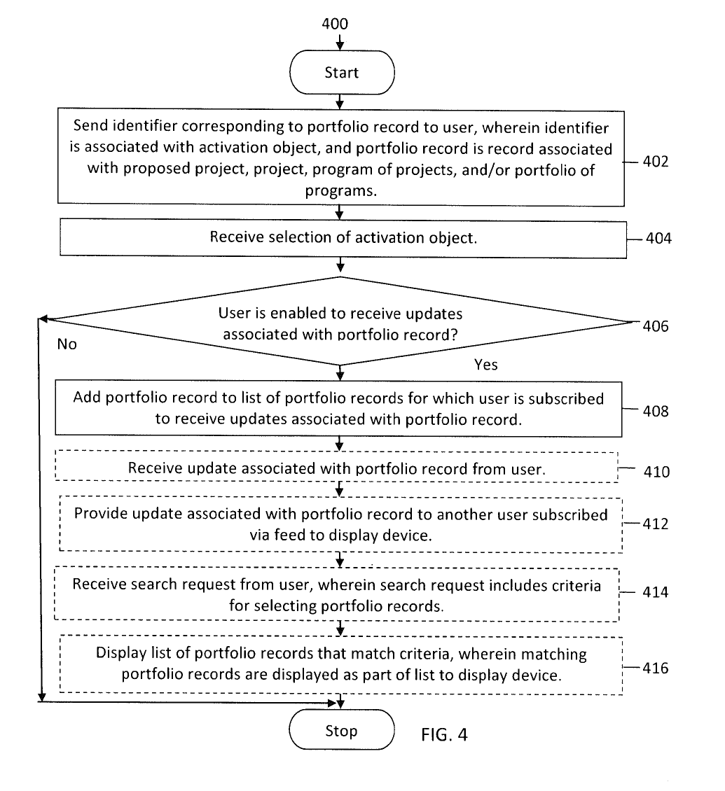

FIG. 4 is a further operational flow diagram illustrating a high level overview of a method 400 for social enterprise portfolio management in an embodiment. As shown in FIG. 4, a system user may select to subscribe to updates of portfolio records, thereby relieving some of a project manager's responsibility for providing every subscription detail for the project manager's project.

In block 402, an identifier corresponding to a portfolio record is sent to a user, wherein the identifier is associated with an activation object, and the portfolio record is a record for a proposed project, a project, a program of projects, and a portfolio of programs. For example, and without limitation, this can include the database system sending buttons that are labeled “subscribe to the small project's health status” and “subscribe to the small project's risk status” to the manager of the large project. In this example, the small project's manager may have provided subscription information to the database system that enables the manager of the large project to receive updates for the small project's due date, but the small project's manager may be unaware if the manager of the large project would benefit from receiving updates for the small project's health status or the small project's risk status.

In block 404, a selection of the activation object is received. By way of example and without limitation, this can include the database system receiving the selection by the manager of the large project of the button labeled “subscribe to the small project's health status.”

In block 406, a determination is made whether the user is enabled to receive updates associated with the portfolio record. In embodiments, this can include the database system determining whether the manager of the large project is enabled to receive updates about the small project's health status. Determining whether the user is enabled to receive updates associated with the portfolio record may include identifying an access level of the user and determining whether the access level enables receiving updates associated with the portfolio record. For example, the small project's manager may assign the manager of the large project a user profile that includes an access level that enables a subscription to the small project's health status and another access level that does not enable a subscription to the small project's risk status. Access levels and user profiles enable a project manager to selectively offer different combinations of subscription offers to various groups of users. If the user is enabled to receive updates associated with the portfolio record, the method 400 continues to block 408. If the user is not enabled to receive updates associated with the portfolio record, the method 400 stops.

In block 408, the portfolio record is added to the list of portfolio records for which the user is subscribed to receive updates associated with the portfolio record. For example, and without limitation, this can include the database system adding the small project's health status to the list of portfolio records for which the manager of the large project is subscribed to receive updates.

In block 410, an update associated with the portfolio record is optionally received from the user. By way of example and without limitation, this can include the database system receiving the message from the manager of the large project about the expensive project's health status.

In block 412, the update associated with the portfolio record is optionally provided to another user subscribed via a feed to a display device. In embodiments, this can include the database system providing the message from the manager of the large project about the expensive project's modified health status to the computing device, mobile phone, laptop computer, and work station of the human resource manager.

In block 414, a search request is optionally received from the user, wherein the search request includes criteria for selecting portfolio records. For example, and without limitation, this can include the database system receiving a search request for the small project's portfolio records from the manager of the large project.

In block 416, a list of portfolio records that match the criteria is optionally displayed, wherein matching portfolio records are displayed as part of a list to the display device. By way of example and without limitation, this can include the database system displaying the list of portfolio records for the small project as part of a subscription options list to the computing device, mobile phone, laptop computer, and work station of the manager of the large project. In some embodiments, the database system may list all matching portfolio records and indicate which portfolio records are available for subscription offers based on the requesting user's access level and/or user profile, or the database system may list all matching portfolio records and apply the requesting user's access levels and/or user profile only after this user requests a subscription to a portfolio record. The capability to selectively subscribe to updates of portfolio records enables users to easily follow updates for only what the users care about, such as specific requests, projects, programs, portfolios, people, risks, issues, and dependencies.

The method 400 may be repeated as desired. Although this disclosure describes the blocks 402-416 executing in a particular order, the blocks 402-416 may be executed in a different order.

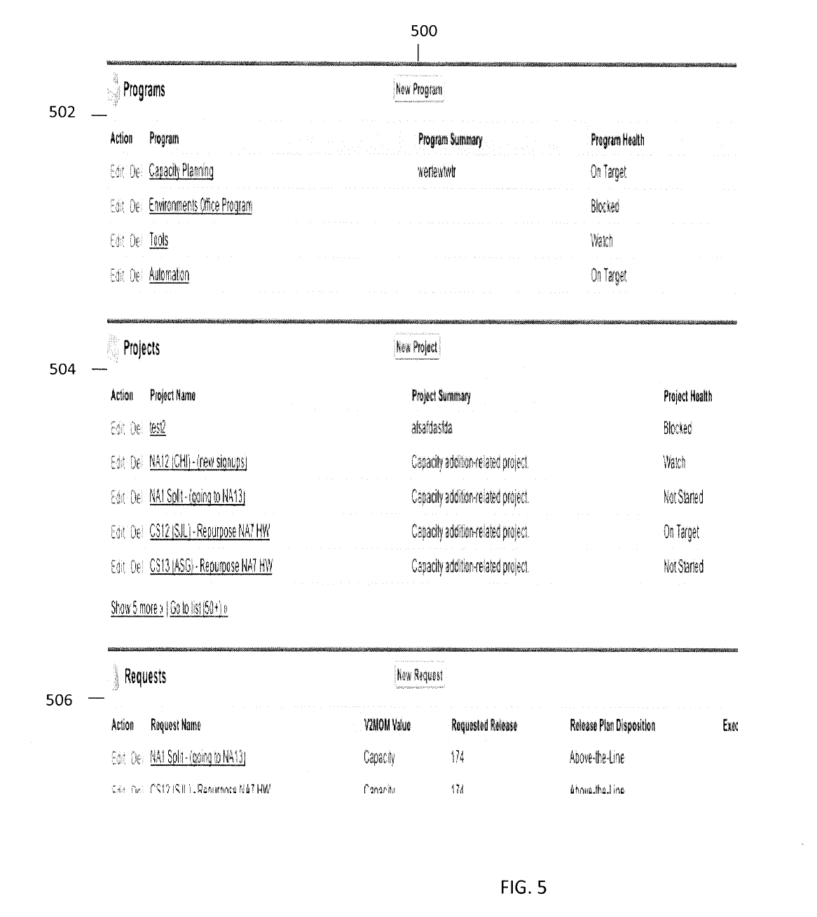

FIG. 5 is a screen shot illustrating a frame 500 of an example user interface screen for providing social enterprise portfolio management in an embodiment. Frame 500 may include a programs 502 section, a projects 504 section, and a requests 506 section for a user's portfolio of projects.

The programs 502 section lists the programs in the user's portfolio, with the corresponding program health statuses and any corresponding program summaries. The user may select the title text field for a listed program to review detailed information for the selected program, such as which projects are associated with the selected program and all of the updates sent for the selected program. The user may also select the corresponding “Edit” field or “Del” field to edit the corresponding program or to delete the corresponding program.

The projects 504 section lists the projects in the user's portfolio, with the corresponding project health statuses and any corresponding project summaries. The user may select the title text field for a listed project to review detailed information for the selected project, such as all of the updates sent for the selected project. The user may also select the corresponding “Edit” field or “Del” field to edit the corresponding project or to delete the corresponding project.

The requests 506 section lists the proposed projects in the user's portfolio, with the corresponding requested release cycles and the corresponding release plan dispositions. The user may select the title text field for a listed request to review detailed information for the selected proposed project, such as all of the updates sent for the selected proposed project. The user may also select the corresponding “Edit” field or “Del” field to edit the corresponding proposed project or to delete the corresponding proposed project.

The frame 500 may be part of a larger display screen that includes fields for users to enter commands to create, retrieve, edit, and store portfolio records. The database system may output a display screen that includes the frame 500 in response to a search based on search criteria input via a user interface. For example, a system user may request to review the portfolio records for the small project.

Because the frame 500 is a sample, the frame 500 could vary greatly in appearance. For example, the relative sizes and positioning of the text is not important to the practice of the present disclosure. The frame 500 can be depicted by any visual display, but is preferably depicted by a computer screen. The frame could also be output as a report and printed or saved in electronic format, such as PDF. The frame 500 can be part of a personal computer system and/or a network, and operated from system data received by the network, and/or on the Internet. The frame 500 may be navigable by a user. Typically, a user can employ a touch screen input or a mouse input device to point-and-click to a location on the frame 500 to manage the text on the frame 500, such as a selection that enables a user to edit the text. Alternately, a user can employ directional indicators, or other input devices such as a keyboard. The text depicted by the frame 500 is an example, as the frame 500 may include a much greater amount of text. The frame 500 may also include fields in which a user can input textual information.

### System Overview

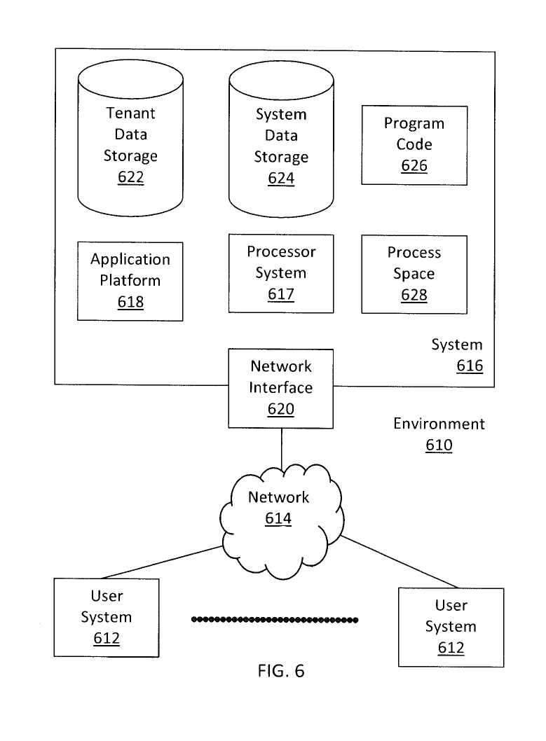

FIG. 6 illustrates a block diagram of an environment 610 wherein an on-demand database service might be used. Environment 610 may include user systems 612, network 614, system 616, processor system 617, application platform 18, network interface 620, tenant data storage 622, system data storage 624, program code 626, and process space 628. In other embodiments, environment 610 may not have all of the components listed and/or may have other elements instead of, or in addition to, those listed above.

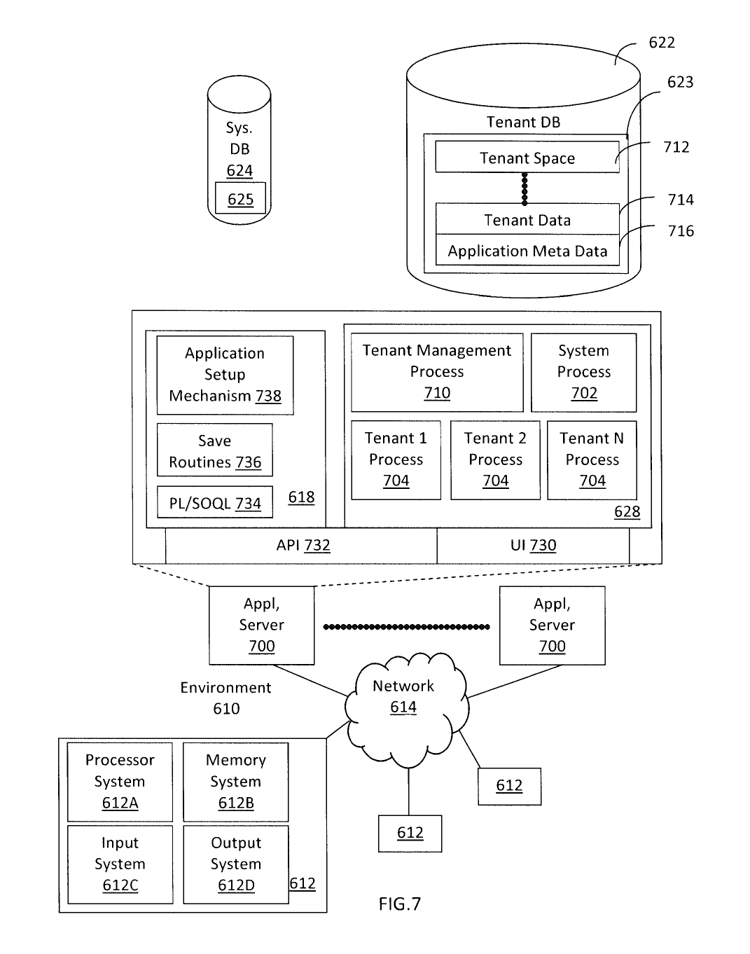

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 16 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 10001-1000N, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 1000 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 34 that provides a programming language style interface extension to API 732. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. An apparatus for social enterprise portfolio management in a multi-tenant database, the apparatus comprising:
a processor; and
one or more stored sequences of instructions which, when executed by the processor, cause the processor to carry out the steps of:
receiving subscription information specifying which users are subscribed to receive updates associated with a portfolio record;
determining whether the subscription information specifies that a user is subscribed to receive updates associated with the portfolio record; and
adding updates associated with the portfolio record to a list of updates that the user receives via a feed to a display device in response to a determination that the user is subscribed to receive updates associated with the portfolio record.

2. The apparatus of claim 1, wherein the subscription information is received from a project manager.

3. The apparatus of claim 1, wherein the portfolio record comprises a record associated with at least one of a proposed project, a current project, a program of projects, and a portfolio of programs.

4. The apparatus of claim 3, wherein the portfolio record further comprises at least one of a report associated with a portfolio record and a dashboard associated with a portfolio record.

5. The apparatus of claim 1, further comprising instructions which, when executed by the processor, cause the processor to carry out the steps of:
receiving a request to review a list of the portfolio records for which the user is subscribed to receive updates;
providing the list of the portfolio records for which the user is subscribed to receive updates;
receiving a request to remove a portfolio record from the list of the portfolio records for which the user is subscribed to receive updates; and
removing the portfolio record from the list of the portfolio records for which the user is subscribed to receive updates.

6. The apparatus of claim 1, further comprising instructions which, when executed by the processor, cause the processor to carry out the steps of:
receiving another update associated with the portfolio record from the user; and
providing the other update associated with the portfolio record to another display device associated with another user subscribed to the feed.

7. The apparatus of claim 6, wherein receiving another update associated with the portfolio record from the user subscribes a previously unsubscribed user to receive updates associated with the portfolio record

8. The apparatus of claim 1, further comprising instructions which, when executed by the processor, cause the processor to carry out the steps of:
receive a request to review the portfolio record; and
provide the portfolio record and any updates associated with the portfolio record to the display device.

9. A machine-readable medium carrying one or more sequences of instructions for social enterprise portfolio management in a multi-tenant database system, which instructions, when executed by one or more processors, cause the one or more processors to carry out the steps of:
receiving a request to modify a portfolio record;
modifying a portfolio record;
determining whether a user is subscribed to receive updates associated with the modified portfolio record; and
providing an update associated with the modified portfolio record to the user via a feed to a display device in response to a determination that the user is subscribed to receive updates associated with the modified portfolio record.

10. The machine-readable medium of claim 9, further comprising instructions for carrying out the steps of:
receiving another update associated with the modified portfolio record from the user; and
providing the other update associated with the modified portfolio record to another user via a feed to another display device.

11. The machine-readable medium of claim 10, wherein receiving another update associated with the modified portfolio record from the user subscribes another user to receive updates associated with the modified portfolio record

12. The machine-readable medium of claim 9, wherein the portfolio record comprises a record associated with at least one of a proposed project, a project, a program of projects, and a portfolio of programs.

13. A method for social enterprise portfolio management in a multi-tenant database system, the method comprising:
receiving a request to receive updates associated with portfolio records for which a user is subscribed to receive updates;
identifying for which portfolio records the user is subscribed to receive updates; and
providing updates for the portfolio records for which the user is subscribed to receive updates via a feed to a display device.

14. The method of claim 13, further comprising:
receiving an update associated with one of the portfolio records from the user; and
providing the update associated with the one of the portfolio records to another user via a feed to another display device.

15. The method of claim 13, wherein receiving an update associated with one of the portfolio records from the user subscribes the other user to receive updates associated with the one of the portfolio records.

16. The method of claim 13, wherein the portfolio records include records associated with at least one of a proposed project, a project, a program of projects, and a portfolio of programs.

17. A method for transmitting code for social enterprise portfolio management in a multi-tenant database system on a transmission medium, the method comprising:
transmitting code to send an identifier corresponding to a portfolio record to a user, wherein the identifier is associated with an activation object;
transmitting code to receive a selection of the activation object;
transmitting code to determine whether the user is enabled to receive updates associated with the portfolio record; and
transmitting code to add the portfolio record to a list of portfolio records for which the user is subscribed to receive updates associated with the portfolio record in response to a determination that the user is enabled to receive updates associated with the portfolio record.

18. The method of claim 17, wherein transmitting code to determine whether the user is enabled to receive updates associated with the portfolio record includes:
transmitting code to identify an access level of the user; and
transmitting code to determine whether the access level enables receiving updates associated with the portfolio record.

19. The method of claim 18, wherein the access level is based on a user profile associated with the user by a project manager.

20. The method of claim 17, further comprising:
transmitting code to receive an update associated with the portfolio record from the user; and
transmitting code to provide the update associated with the portfolio record to another user via a feed to a display device.

21. The method of claim 17, wherein the portfolio record comprises a record associated with at least one of a proposed project, a project, a program associated with projects, and a portfolio of projects.

22. The method of claim 17, wherein the portfolio record has a name in text, and wherein the identifier comprises the name.

23. The method of claim 17, wherein the activation object comprises a button labeled to indicate a function of subscribing to the portfolio record.

24. The method of claim 17, further comprising:
transmitting code to receive a search request from the user, wherein the search request includes criteria for selecting portfolio records; and
transmitting code to display a list of portfolio records that match the criteria, wherein matching portfolio records are displayed as part of the list.
